(19) United States
(12) Patent Application Publication
(10) Pub. No.: US 2007/0057634 A1
(43) Pub. Date: Mar. 15, 2007

(54) PLASMA DISPLAY PANEL

(75) Inventor: Jongrae LIM, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/530,068

(22) Filed: Sep. 8, 2006

(30) Foreign Application Priority Data
Sep. 9, 2005 (KR) 10-2005-0084041

(51) Int. Cl. H01J 1/62

(52) U.S. Cl. 313/512

(57) ABSTRACT

Provided is a plasma display panel in which a front substrate and a rear substrate are spaced a predetermined distance apart and sealed. The rear substrate comprises an address electrode, a scan electrode and a sustain electrode spaced apart from the address electrode, a dielectric layer provided to insulate the scan electrode, the sustain electrode, and the address electrode with each other, and a barrier rib provided on the dielectric layer. A thickness of the dielectric layer in a region between the scan electrode and the sustain electrode in a discharge cell is different from a thickness of the dielectric layer in remaining region of the discharge cell.

This Nonprovisional application claims priority under 35 U.S.C. §119 (a) on Patent Application No. 10-2005-0084041 filed in Korea on Sep. 9, 2005 the entire contents of which are hereby incorporated by reference.

### BACKGROUND

1. Field

The present invention relates to a plasma display panel.

2. Description of the Background Art

In general, a plasma display panel comprises a phosphor layer within a discharge cell partitioned by a barrier rib, and comprises a plurality of electrodes to apply a driving signal to the discharge cell.

In the plasma display panel, when the driving signal is applied to the discharge cell, a discharge gas filled in the discharge cell generates vacuum ultraviolet rays. The vacuum ultraviolet rays excite phosphors provided within the discharge cell, thereby embodying an image.

### SUMMARY

Accordingly, an object of the present invention is to provide a plasma display panel for improving an efficiency of light emission.

In one aspect, there is provided a plasma display panel in which a front substrate and a rear substrate are spaced a predetermined distance apart and sealed. The rear substrate comprises an address electrode, a scan electrode and a sustain electrode spaced apart from the address electrode, a dielectric layer provided to insulate the scan electrode, the sustain electrode, and the address electrode with each other, and a barrier rib provided on the dielectric layer a thickness of the dielectric layer in a region between the scan electrode and the sustain electrode in a discharge cell is different from a thickness of the dielectric layer in remaining region of the discharge cell

In another aspect, there is provided a plasma display panel. The plasma display panel comprises a front substrate having a barrier rib formed thereon, and a rear substrate spaced a predetermined distance apart from the front substrate. The rear substrate comprises an address electrode, a scan electrode and a sustain electrode spaced apart from the address electrode, and a dielectric layer provided to insulate the scan electrode, the sustain electrode, and the address electrode with each other. A gap between the scan electrode and the sustain electrode is greater than a height of the barrier rib.

It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 is a perspective view illustrating a plasma display panel according to an embodiment of the present invention;

FIG. 2 is a cross sectional view illustrating the plasma display panel of FIG. 1;

FIG. 3 is a plan view illustrating an electrode arrangement structure of a plasma display panel according to an exemplary embodiment of the present invention;

FIG. 4 is a flowchart illustrating a method for manufacturing the plasma display panel of FIG. 2;

FIG. 5 is a perspective view illustrating a plasma display panel according to another exemplary embodiment of the present invention;

FIG. 6 is a cross sectional view illustrating the plasma display panel of FIG. 5;

FIG. 7 illustrates a plasma display apparatus comprising a plasma display panel and drivers for driving the plasma display panel according to the present invention; and

FIG. 8 is a diagram illustrating a detailed driving method of a plasma display panel according to the present invention.

### DETAILED DESCRIPTION OF PREFERRED EMBODIMENTS

Preferred embodiments of the present invention will be described in a more detailed manner with reference to the drawings.

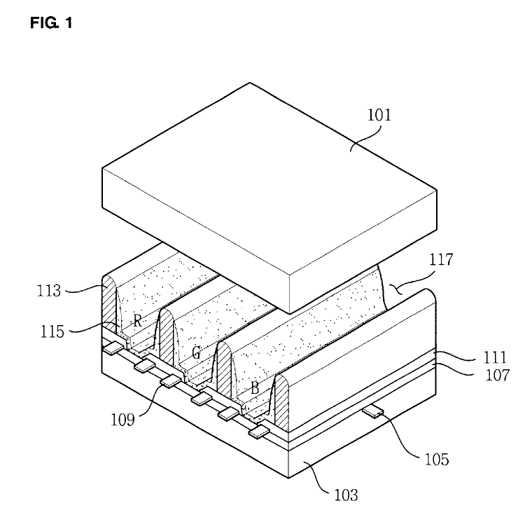

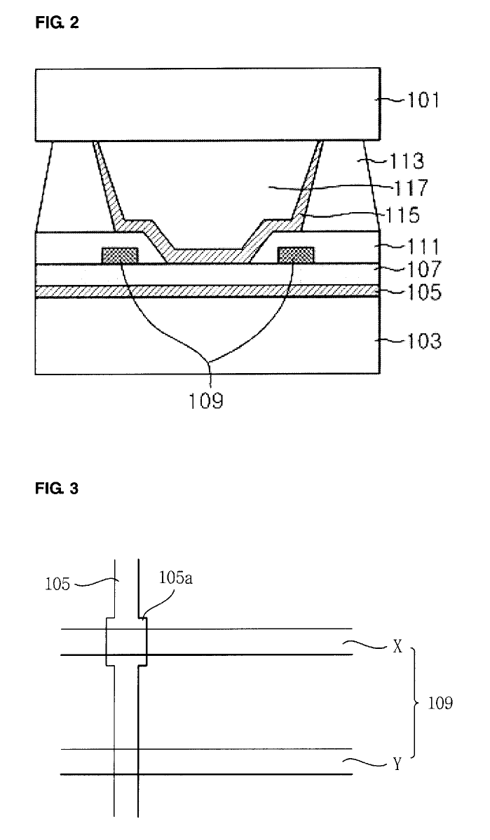

FIG. 1 is a perspective view illustrating a plasma display panel according to an exemplary embodiment of the present invention, and FIG. 2 is a cross sectional view illustrating the plasma display panel of FIG. 1.

Referring to FIGS. 1 and 2, the plasma display panel according to an exemplary embodiment of the present invention is formed by sealing a front substrate 101 and a rear substrate 103 at a predetermined distance.

The front substrate 101 is formed of a silica-based glass, and is in direct contact with a barrier rib provided at the rear substrate 103 to be described later. In other words, neither an electrode for discharge nor a dielectric layer for insulating the barrier rib is provided at the front substrate.

The rear substrate 103 comprises an address electrode 105, dielectric layers 111 and 107, a sustain electrode pair 109, the barrier rib 113, and a phosphor layer 115.

The sustain electrode pair 109 comprises a scan electrode (X) and a sustain electrode (Y). The barrier rib 113 forms a discharge cell between the front substrate 101 and the rear substrate 103, and forms a plasma display discharge space 117.

The address electrode 105 is provided in parallel in a straight-line type on the rear substrate 103. The address electrode 105 may have various shapes so that it can improve a jitter characteristic at the time of an address discharge. This will be described later.

The dielectric layer comprises a first dielectric layer 107 and a second dielectric layer 111. The first dielectric layer 107 is provided in a flat shape on the address electrode 105 to limit a discharge current in discharge and facilitate generation of wall charges.

The sustain electrode pair 109 is provided on the first dielectric layer 107 to cross at right angles with the address electrode 105. An interval is provided between the scan electrode (X) and the sustain electrode (Y) constituting the sustain electrode pair 109, as a long gap for inducing a discharge in a positive column region in plasma discharge and improving an efficiency. Preferably, the interval between the scan electrode (X) and the sustain electrode (Y) is provided greater than a height of the barrier rib 113.

The interval between the scan electrode (X) and the sustain electrode (Y) may be different depending on a size of the discharge cell. Preferably, the interval between the scan electrode (X) and the sustain electrode (Y) ranges from about 300 μm to 500 μm.

The second dielectric layer 111 is provided to cover the sustain electrode pair 109 so that it can have a differential structure in which its thickness is small at an electric field concentration part of the sustain electrode pair 109 and is large at an electric field available part centering around the plasma discharge region 117.

In other words, a thickness of the second dielectric layer in a region between the scan electrode and the sustain electrode in a discharge cell is less than a thickness of the second dielectric layer in remaining region of the discharge cell. The thickness of the first dielectric layer 107 is less than the thickness of the second dielectric layer 111.

The first dielectric layer 107 is provided in a type of a film such as a green sheet.

The first dielectric layer 107 can induce a stable discharge owing to its good uniformity.

A protective layer (not shown) can be provided on the first dielectric layer 107 and the second dielectric layer 111, to prevent the dielectric layers 107 and 111 from being damaged due to a sputtering generated in plasma discharge, and increase a discharge efficiency of secondary electrons.

The barrier rib 113 is provided on the second dielectric layer 111 between cells to distinguish each cell. The phosphor layer 115 is provided on a side surface of the barrier rib 113 and a bottom surface of the discharge cell.

FIG. 3 is a plan view illustrating an electrode arrangement structure of a plasma display panel according to an exemplary embodiment of the present invention.

Referring to FIG. 3, the address electrode 105 of the rear substrate comprises a protrusion 105a in a position corresponding to the scan electrode (X) provided on the first dielectric layer 107, so that the discharge region 117 is widened in address discharge between the scan electrode (X) and the address electrode 105. The protrusion 105a can protrude only in one direction of the address electrode 105. Alternately, the protrusion 105a can protrude in both directions of the address electrode 105 as shown in FIG. 3.

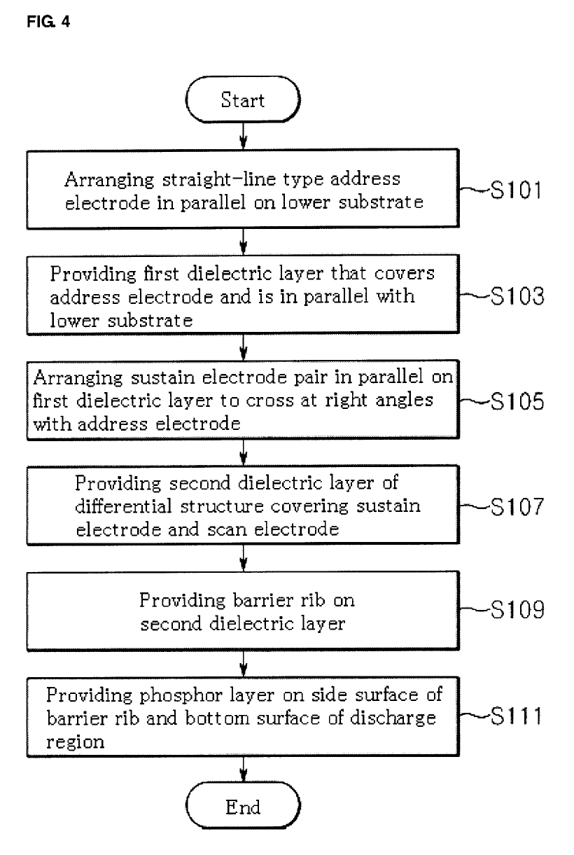

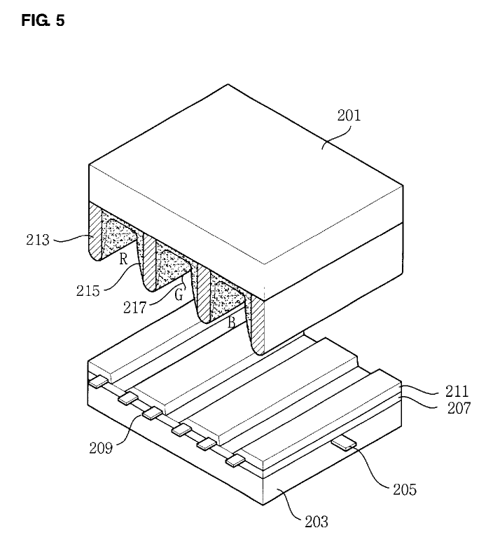

FIG. 4 is a flowchart illustrating a method for manufacturing the plasma display panel of FIG. 2.

Referring to FIG. 4, a plurality of the address electrodes 105 is arranged in parallel on the lower substrate (Step 101). This may be performed using a vacuum deposition process and a photolithography process.

After that, the first dielectric layer 107 is provided on the lower substrate comprising the address electrode (Step 103). The first dielectric layer 107 may be provided by coating dielectric slurry on the address electrode 105, but may be provided on the address electrode 105 using the film type green sheet.

Next, the sustain electrode pair 109 is arranged on the first dielectric layer 107 to cross at right angles with the address electrode 105 (Step 105). Either the sustain electrode pair 109 may be performed using the vacuum deposition process and the photolithography process, or the sustain electrode pair 109 may be performed using a dispensing process.

After that, the second dielectric layer 111 is provided on the sustain electrode pair 109 (Step 107). The second dielectric layer 111 (1can be patterned using a coating process and the photolithography process or a sand blasting process. In this embodiment, it is shown that the second dielectric layer 111 existing between the sustain electrode pair 109 is all patterned. However, with no limitation to this, either only a part of the second dielectric layer 111 can be patterned, or up to a part of the first dielectric layer 107 can be patterned.

Next, the barrier rib 113 is provided on the second dielectric layer 111 using a method such as a sand blasting process or a photolithography process (Step 109). Preferably, in the case of employing the photolithography process, the barrier rib 113 can be of a shape where its width is large near the lower substrate and is small near the upper substrate.

After that, phosphors are dispensed to the bottom surface of the discharge cell and the side surface of the barrier rib, respectively, thereby completing the manufacture of the lower substrate (Step 111).

After the forming of the address electrode 105, the first dielectric layer 107, the sustain electrode pair 109, the second dielectric layer 111, the barrier rib 113, and the phosphor layer 115 on the lower substrate 103 as above, the lower substrate 103 is sealed with the upper substrate 101, a vacuum exhaustion is performed, and two or three-component inertia gas comprising xenon (Xe) is injected inside, thereby completing the plasma display panel.

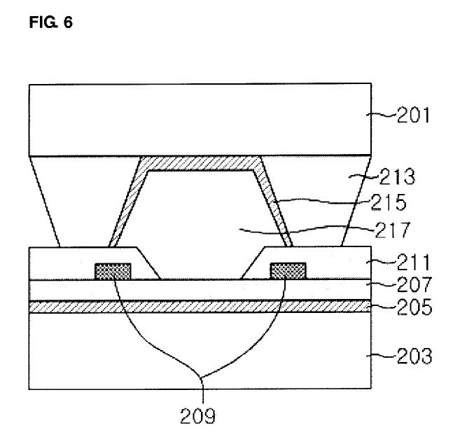

FIG. 5 is a perspective view illustrating a plasma display panel according to another exemplary embodiment of the present invention, and FIG. 6 is a cross sectional view illustrating the plasma display panel of FIG. 5.

Referring to FIGS. 5 and 6, the plasma display panel according to another exemplary embodiment of the present invention has the same construction as the plasma display panel of FIGS. 1 and 2 and thus, its description will be omitted. However, the plasma display panel is different in construction from the plasma display panel of FIGS. 1 and 2 in that a barrier rib is provided on a front substrate, and a phosphor layer is provided on a side surface of the barrier rib and a bottom surface of the front substrate.

A method for manufacturing the plasma display panel according to another exemplary embodiment of the present invention is equal to the method for manufacturing the plasma display panel shown in FIG. 4 and thus, its description will be omitted.

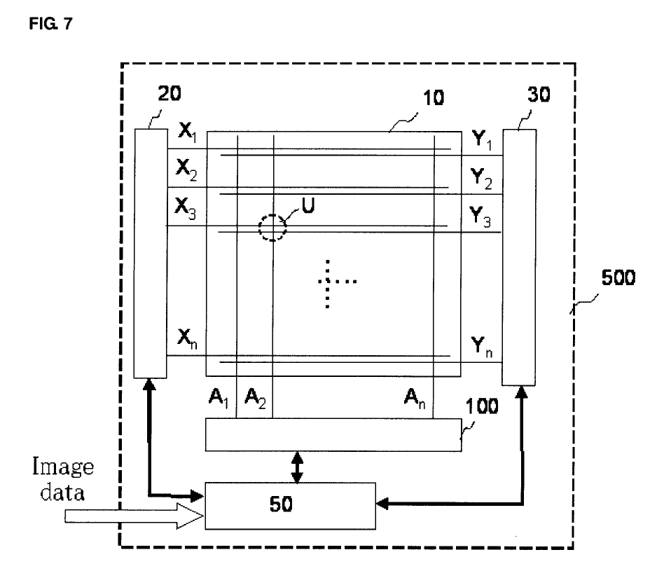

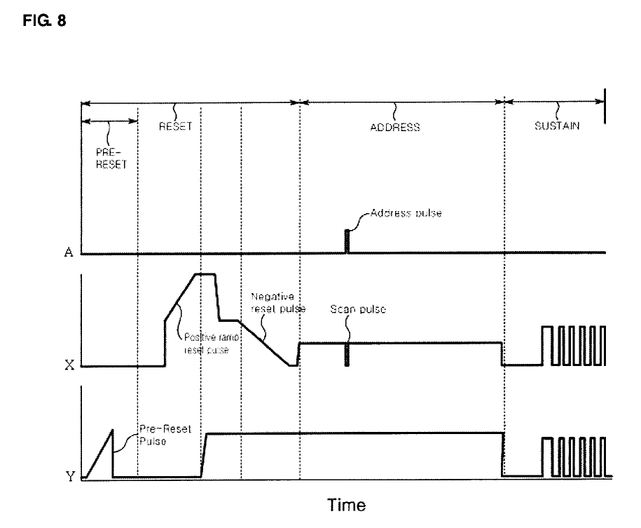

FIG. 7 illustrates a plasma display apparatus comprising a plasma display panel and drivers for driving the plasma display panel according to the present invention. FIG. 8 is a diagram illustrating a detailed driving method of the plasma display panel according to the present invention.

Referring to FIG. 7, the plasma display apparatus comprises the plasma display panel 10, the drivers 20, 30, and 100 for driving the plasma display panel 10, and a controller 50.

The plasma display panel comprises a plurality of scan electrodes (X₁, X₂, . . . , Xₙ) and a plurality of sustain electrodes (Y₁, Y₂, . . . , Yₙ) in parallel with each other, and a plurality of address electrodes (A₁, A₂, . . . , Aₙ) arranged in a direction crossing at right angles with the plurality of sustain electrodes (X₁, X₂, . . . , Xₙ) and scan electrodes (Y₁, Y₂, . . . , Yₙ). Each electrode is driven using the sustain driver 20, the scan driver 30, and the data driver 100.

The controller 50 controls the respective drivers 20, 30, and 100 depending on image data received from the exterior.

The plasma display apparatus is driven in a method of FIG. 8 below.

The plasma display panel is driven with one frame divided into a plurality of subfields, and each subfield again divided into a reset period, an address period, and a sustain period.

Referring to FIG. 8, in an initialization period, a predetermined reset waveform is sequentially applied to the scan electrode (X) and the sustain electrode (Y), and makes an initial condition of a whole cell identical.

Next, in the address period, a cell to be discharged in the subsequent discharge sustain period is selected. The discharge cell is selected by the scan electrode (X) and the address electrode (A) crossing at right angles with each other. A voltage applied to the cell induces a discharge in the selected cell, thereby forming positive wall charges on the scan electrode (X) and forming negative wall charges on the address electrode (A), respectively.

In the sustain period, a discharge sustain voltage lower than a discharge firing voltage is applied between the scan electrode (X) and the discharge sustain electrode (Y) so that a sustain discharge can be kept only in an on-cell turning on in the address period. Accordingly, the sustain discharge is kept only in the cell, which is selected by the scan electrode (X) and the address electrode (A) in the address period, thereby inducing the discharge.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel in which a front substrate and a rear substrate are spaced a predetermined distance apart and sealed, the panel comprising:
the rear substrate comprising:
an address electrode;
a scan electrode and a sustain electrode spaced apart from the address electrode;
a dielectric layer provided to insulate the scan electrode, the sustain electrode, and the address electrode with each other; and
a barrier rib provided on the dielectric layer,
wherein a thickness of the dielectric layer in a region between the scan electrode and the sustain electrode in a discharge cell is different from a thickness of the dielectric layer in remaining region of the discharge cell.

2. The plasma display panel of claim 1, wherein the dielectric layer comprises a first dielectric layer and a second dielectric layer,
the first dielectric layer covers the address electrode in a flat shape, and
a thickness of the second dielectric layer in a region between the scan electrode and the sustain electrode in a discharge cell is less than a thickness of the second dielectric layer in remaining region of the discharge cell.

3. The plasma display panel of claim 2, wherein the thickness of the first dielectric layer is less than the thickness of the second dielectric layer.

4. The plasma display panel of claim 2, wherein the first dielectric layer is provided in a film type.

5. The plasma display panel of claim 1, wherein the address electrode comprises a protrusion in a position corresponding to the scan electrode.

6. The plasma display panel of claim 1, wherein a gap between the scan electrode and the sustain electrode ranges from about 200 μm to 500 μm.

7. The plasma display panel of claim 1, wherein a phosphor layer is provided on a side surface of the barrier rib and a top surface of the dielectric layer.

8. The plasma display panel of claim 1, wherein the front substrate is in direction contact with the barrier rib.

9. The plasma display panel of claim 1, wherein the scan electrode and the sustain electrode consist of a metal electrode each.

10. A plasma display panel comprising:
a front substrate having a barrier rib formed thereon; and
a rear substrate spaced a predetermined distance apart from the front substrate,
the rear substrate comprising:
an address electrode;
a scan electrode and a sustain electrode spaced apart from the address electrode; and
a dielectric layer provided to insulate the scan electrode, the sustain electrode, and the address electrode with each other,
wherein a gap between the scan electrode and the sustain electrode is greater than a height of the barrier rib.

11. The plasma display panel of claim 10, wherein a thickness of the dielectric layer in a region between the scan electrode and the sustain electrode in a discharge cell is different from a thickness of the dielectric layer in remaining region of the discharge cell.

12. The plasma display panel of claim 10, wherein the dielectric layer comprises a first dielectric layer and a second dielectric layer,
the first dielectric layer covers the address electrode in a flat shape, and
a thickness of the second dielectric layer in a region between the scan electrode and the sustain electrode in a discharge cell is less than a thickness of the second dielectric layer in remaining region of the discharge cell.

13. The plasma display panel of claim 12, wherein the thickness of first dielectric layer is less than the thickness of the second dielectric layer.

14. The plasma display panel of claim 12, wherein the first dielectric layer is provided in a film type.

15. The plasma display panel of claim 10, wherein the address electrode comprises a protrusion in a position corresponding to the scan electrode.

16. The plasma display panel of claim 10, wherein a gap between the scan electrode and the sustain electrode ranges from about 200 μm to 500 μm.

17. The plasma display panel of claim 10, wherein a phosphor layer is provided on a side surface of the barrier rib and a bottom surface of the front substrate.

18. The plasma display panel of claim 10, wherein the scan electrode and the sustain electrode consist a metal electrode each.
